(19) United States
(12) Patent Application Publication
(10) Pub. No.: US 2013/0029224 A1
(43) Pub. Date: Jan. 31, 2013

(54) LITHIUM ELECTROCHEMICAL GENERATOR COMPRISING TWO TYPES OF DISTINCT ELECTROCHEMICAL CELLS

(71) Applicants: Florence Fusalba, Aix-Lex Bains (FR); Sébastien Martinet, St. Quentin Sur Isere (FR)

(72) Inventors: Florence Fusalba, Aix-Lex Bains (FR); Sébastien Martinet, St. Quentin Sur Isere (FR)

(73) Assignee: Commissariat a l'energie atomique et aux energies alternatives, Paris (FR)

(21) Appl. No.: 13/520,913

(22) PCT Filed: Jan. 12, 2011
(86) PCT No.: PCT/EP11/50354

§ 371 Date: Jul. 17, 2012

(30) Foreign Application Priority Data
Jan. 14, 2010 (FR) 10 50230

(51) Int. Cl. H01M 4/485; H01M 4/525; H01M 4/505; H01M 4/583; H01M 4/56

(52) U.S. Cl. 429/220; 429/231.95; 429/231.8; 429/221; 429/223; 429/224; 429/231.2; 429/231.3; 429/231.6

(57) ABSTRACT

An electrochemical generator comprising a first type of electrochemical cell, a so-called <<high energy>> cell and a second type of electrochemical cell a so-called <<safety>> cell is provided.

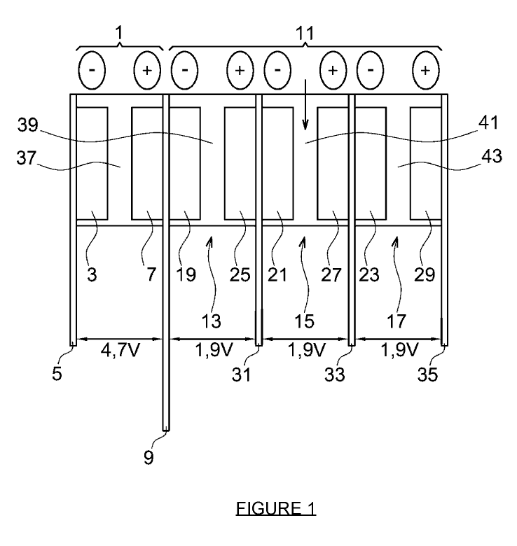

### TECHNICAL FIELD

The present invention relates to a generator with a so-called bipolar architecture comprising two types of electrochemical cells, giving the possibility of associating within a same generator, cells delivering a large voltage and thus having a large storage capacity, with so-called safety cells delivering a lower voltage but based on more stable materials.

The generators of the invention find their application in sectors where energy and power are required while calling for significant safety standards.

The field of the invention may thus be considered as the field of energy storage devices.

### STATE OF THE PRIOR ART

Among existing energy storage devices, mention may be made of electrochemical generators operating on the principle of electrochemical cells mounted in series or even in parallel, capable of delivering electric current, by the presence in each of them of a pair of electrodes (an anode and a cathode, respectively) separated by an electrolyte, the electrodes being in specific materials capable of reacting together according to an oxidation-reduction reaction by means of which there is production of electrons at the origin of electric current and production of ions which will circulate from one electrode to the other by means of an electrolyte.

Specific generators subscribing to this principle are lithium generators which operate on the principle of intercalation-deintercalation of lithium.

More specifically, the reaction at the origin of the production of current (i.e when the generator is in a discharge mode) sets into play, via an electrolyte conducting lithium ions, the transfer of lithium cations from a negative electrode which will be inserted into the acceptor lattice of the positive electrode, while electrons from the reaction at the negative electrode will feed the outer circuit to which are connected the positive and negative electrodes.

The first lithium generators included lithium metal at their negative electrodes, which provided high voltage and excellent mass and bulk energy densities. However, investigations revealed that repeated recharging operations of this type of generator are inevitably accompanied with the formation of lithium dendrites which will most frequently deteriorate the separator comprising the electrolyte.

In order to circumvent the problems of instability, safety and lifetime inherent to lithium metal used for making up negative electrodes, the investigations were reoriented so as to set into place generators based on non-metal lithium, notably on the basis of electrochemical cells including the following types of electrodes:
a negative electrode based on a carbonaceous material, such as graphite;
a positive electrode based on an oxide of a lithiated transition metal of the LiMO₂ type, wherein M designates Co, Ni, Mn.

It is this type of configuration which is again found in the generators described in U.S. Pat. No. 5,595,839 which discloses a stack cell architecture consisting of a stack of electrochemical cells, the junction between two adjacent electrochemical cells being ensured by a bipolar structural unit comprising a positive electrode (belonging to one cell) and a negative electrode (belonging to the adjacent cell) positioned on either side of two substrates placed side by side forming an assembly, the substrates on the negative electrode side being a copper substrate and the substrate on the positive electrode side being an aluminium substrate.

It is also this type of configuration which is again found in WO 03/047021 with an aluminium substrate both on the positive electrode side and on the negative electrode side.

Because of the constitution of the electrodes, each cell is able to deliver a large voltage and thus a strong energy density which leads to the fact that, when all the cells of a stack operate, this may generate a significant rise in the temperature of the stack, or even thermal runaway which propagates from cells to cells, which, if it is not repressed, may cause irreversible degradation of the generator, such as destruction by melting of the separators containing the electrolyte. Therefore it is sometimes indispensable to provide such generators with specific safety means, such as circuit breaker systems, vent systems.

However, providing this type of safety system is detrimental to the compactness of the generator and also contributes to reducing the mass and bulk energy performances of these accumulators.

The inventors thus set the goal of proposing generators based on a bipolar architecture, which may deliver a strong energy density while being intrinsically safe, i.e. without requiring resorting to specific safety systems as those mentioned above.

### DISCUSSION OF THE INVENTION

The inventors had the surprising idea of associating within a same generator, two distinct types of electrochemical cells, one of the types of which is able to form safety elements with regard to the other type of electrochemical cells in the case of thermal runaway due to the electrochemical reaction occurring in this other type of cells.

Thus, the invention relates to an electrochemical generator comprising:
at least one first electrochemical cell comprising:
a positive electrode comprising a material selected from lithiated oxide comprising manganese with a spinel structure, lithiated oxides with a lamellar structure and mixtures thereof;
a negative electrode comprising a material selected from carbonaceous materials, mixed lithium and titanium oxides, titanium dioxide and mixtures thereof;
an electrolyte comprised between said positive electrode and said negative electrode; and
at least one second electrochemical cell comprising:
a positive electrode comprising a material selected from lithiated oxides with polyanionic structures of formula LiM_{y}(XO_{z})ₙ with M representing an element selected from Mn, Fe, Co, Ni, Cu, Mg, Zn, V, Ca, Sr, Ba, Ti, Al, Si, B and Mo, X representing an element selected from P, Si, Ge, S and As, y, z and n being positive integers;
a negative electrode comprising a material selected from mixed lithium and titanium oxides, titanium dioxide and mixtures thereof; and
an electrolyte comprised between said positive electrode and said negative electrode;

at least one of said first electrochemical cells and at least one of said second electrochemical cells being connected to each other through an electrically conducting substrate supporting on one of its faces an electrode of said first electrochemical cell and on another face an electrode of said second electrochemical cell.

Before giving more details in the discussion of this invention, we specify the following definitions.

By positive electrode is conventionally meant, in the foregoing and in the following, the electrode which acts as a cathode, when the generator outputs current (i.e. when it is in a discharge process) and which acts as an anode when the generator is in a charging process.

By negative electrode is conventionally meant, in the foregoing and in the following, the electrode which acts as an anode, when the generator outputs current (i.e. when it is in a discharge process) and which acts as a cathode, when the generator is in a charging process.

By selecting the constitutive materials of the electrodes of the first and second electrochemical cells, we thus end up with a first electrochemical cell able to deliver a large voltage, accompanied by a significant release of energy (this may thus be referred to as a <<high energy>> cell) and with a second electrochemical cell able to deliver a lower voltage than that of the first cell, with faster charging and discharging rates (this may thus be referred to as a <<high power>> cell) and which, by the thermal stability of the constitutive material of its electrodes as compared with that of the materials of the first cell, will be able to allow good dissipation of heat emitted by the first cell and thereby avoid a thermal runaway propagation phenomenon. The second electrochemical cell thus plays the role of <<buffer>> cells giving the possibility of ensuring the safety of the generator.

Furthermore, by means of the generators of the invention, it is possible to obtain at the output of the latter, an output voltage which may be modulated depending on the contemplated application, according to whether both first and second electrochemical cells are connected or whether only a portion of them is connected. By connecting, according to the contemplated application, only a portion of the cells with view to delivering a voltage, it is thus proceeded with putting the portion of non-connected cells in reserve and the lifetime of the generators of the invention may thereby be improved by managing the putting into operation of the cells.

To do this, the generators of the invention may be provided with electric connections to said first electrochemical cell and with electric connections to said second electrochemical cell.

Because the generators of the invention give the possibility, by means of the presence of the second electrochemical cells of doing without safety systems, one thus has access to generators having a lowered internal resistance as compared with a generator having such systems, which may prove to be important for a power application or for a low temperature operation.

Furthermore, the presence of cell(s) of the type of the second electrochemical cells described above gives the possibility of getting rid of the problems related to the degradation of the electrolyte or even of the separator containing the electrolyte, these cells being able to absorb without any degradation the energy delivered by the cells of the type of the first electrochemical cells as defined above.

Because of the use of an electrically conducting support, common to the first electrochemical cell and to the second electrochemical cell, one also has access to more compact, more robust generator architectures having a lowered internal resistance (which may be important for a power application or for low temperature operation).

As mentioned above, the first electrochemical cell comprises, as a positive electrode material, a material selected from lithiated oxides comprising manganese with a spinel structure and lithiated oxides of a lamellar structure.

Among the lithiated oxides comprising manganese with a spinel structure, mention may be made of lithiated oxides fitting the following formula:

Li₁₋ₐNi_{0.5-b}Mn_{1.5-c}O_{4-d}

with a, b, c and d being comprised between −0.5 and +0.5, for example between −0.1 and +0.1, i.e. each of the parameters, a, b, c and d is greater than or equal to −0.5 and less than or equal to +0.5 (when a, b, c and d are comprised between −0.5 and +0.5), for example greater than or equal to −0.1 and less than or equal to +0.1 (when a, b, c and d are comprised between −0.1 and +0.1).

In particular, a lithiated oxide according to this definition and particularly advantageous is the oxide of formula LiNi_{0.5}Mn_{1.5}O₄, which has the particularity of having a lithium insertion/deinsertion potential of the order of 4.7 V (this potential being expressed relatively to the reference pair Li⁺/Li).

Mention may also be made, as lithiated oxides comprising manganese with a spinel structure, of lithiated oxides of formulae LiMn₂O₄ or LiNiMnO₄.

Among the lithiated oxides with a lamellar structure, mention may advantageously be made of lithiated oxides fitting the following formula:

LiMO₂

wherein M is an element selected from Ni, Co, Mn, Al and mixtures thereof.

As examples of such oxides, mention may be made of the lithiated oxides LiCoO₂, LiNiO₂ and the mixed oxides Li(Ni,Co,Mn)0₂ (such as Li(Ni_{1/3}Mn_{1/3}Co_{1/3})O₂) also known under the name of NMC), Li(Ni,Co,Al)O₂ (such as Li(Ni_{0.8}Co_{0.15}Al_{0.05})O₂ also known under the name of NCA) or Li(Ni,Co,Mn,Al)O₂.

In particular, the oxides Li(Ni_{0.8}Co_{0.15}Al_{0.05})O₂ and Li(Ni_{1/3}Mn_{1/3}Co_{1/3})O₂ give the possibility of attaining similar or substantially higher electrochemical performances than the oxides of the LiMO₂ (with M representing a single metal and not a mixture) for a lower or equivalent cost and improved chemical stability in particular in the charged state.

These may also be lithiated oxides with a lamellar structure fitting the following general formula:

LiM₂O₃

wherein M is an element selected from Ni, Co, Mn, Al and mixtures thereof.

As examples of such oxides, mention may be made of lithiated oxides with a lamellar structure LiMn₂O₃.

The positive electrode material may also be a mixture of LiMO₂ and of LiM₂O₃ corresponding to the formulae as defined above.

The negative electrode of the first electrochemical cell may be a negative electrode in a carbonaceous material, which may be:
carbon, for example in one of its allotropic forms, such as graphite;
a composite material comprising carbon and another element such as silicon and tin.

The negative electrode of the first electrochemical cell may also be a negative electrode in a material selected from mixed oxides of titanium and lithium, such as Li₄Ti₅O₁₂, titanium dioxide and mixtures thereof.

By selecting the constitutive materials of the positive and negative electrodes of the first electrochemical cell, one thus has access to an electrochemical cell capable of delivering a large voltage and thus, substantial energy, which may be accompanied by substantial heat evolvement.

In order to ensure propagation of the heat, without any adverse effect on the integrity of the generator, at least one of the first electrochemical cells is in contact with a second electrochemical cell via an electrically conducting substrate as defined above, the second electrochemical cell being based on electrodes in materials capable, because of their thermal stability, of storing up the heat emitted by the reaction occurring at the first electrochemical cell.

To do this, the selection of the constitutive materials of the electrodes of the second electrochemical cells is made in a motivated way in order to meet these thermal stability conditions.

Thus, the second electrochemical cell, as mentioned above, comprises as a positive electrode, an electrode in a material selected from lithiated oxides with polyanionic structures of formula LiM_{y}(XO_{z})ₙ with M representing an element selected from Mn, Fe, Co, Ni, Cu, Mg, Zn, V, Ca, Sr, Ba, Ti, Al, Si, B and Mo, X representing an element selected from P, Si, Ge, S and As, y, z and n being positive integers.

Advantageously, X may be P, in which case the lithiated oxide with polyanionic structures is a lithium phosphate, such as LiFePO₄.

X may be Si, in which case the lithiated oxide is a lithium silicate.

As a negative electrode for the second electrochemical cell, this is an electrode in a material selected from mixed oxides of titanium and lithium, preferably Li₄Ti₅O₁₂, titanium dioxide and mixtures thereof.

Because of the nature of the constitutive materials of the positive and negative electrodes of the second electrochemical cell, the latter, while being capable of delivering a lower voltage than the first electrochemical cell, has considerable thermal stability, which results in that it will be able to ensure a <<safety>> cell function by being able to absorb the energy delivered by the first electrochemical cell thereby avoiding any propagation of a possible thermal runaway.

A generator specific to the invention may be an electrochemical generator comprising at least one first electrochemical cell comprising a positive electrode in LiNi_{0.5}Mn_{1.5}O₄ and a negative electrode in graphite and at least one second electrochemical cell comprising a positive electrode in LiFePO₄ and a negative electrode in Li₄Ti₅O₁₂.

Whether this be for the first electrochemical cell or for the second electrochemical cell, the positive electrode and the negative electrode of a given cell are separated from each other by an electrolyte, which may be of the same nature for all the cells of the generator, which electrolyte may impregnate a separator for example in a polymeric material.

The electrolyte may comprise a solvent in which a lithium salt is dissolved. The solvent may be a carbonate solvent, such as ethylene carbonate, propylene carbonate, dimethyl carbonate, diethyl carbonate and mixtures thereof, an ether solvent such as dimethoxyethane, dioxolane, dioxane and mixtures thereof and/or a nitrile solvent, such as acetonitrile.

The lithium salt may, as for it, be selected from the group formed by LiPF₆, LiClO₄, LiBF₄, LiAsF₆.

Advantageously, the electrolyte may also be an ionic liquid based on lithium ions, i.e. a salt consisting of lithium cations, complexed with inorganic or organic anions, which have the property of being in the liquid state at room temperature. An ionic liquid, depending on the nature of the anion, may be hydrophilic or hydrophobic.

The ionic liquids used as an electrolyte allow good charge transfer and greater thermal stability, are non-volatile and non-flammable and therefore give the possibility of improving the degree of safety of the generators in which they are included. They thus allow a large range of operating temperatures.

As examples of ionic liquids, mention may be made of ionic liquids based on hydrophobic anions such as trifluoromethanesulfonate (CF₃SO₃), bis(trifluoromethanesulfonate)imide [(CF₃SO₂)₂N] and tris(trifluoromethanesulfonate)methide [(CF₃SO₂)₃C].

The aforementioned electrically conducting support is advantageously in aluminium.

The generators of the invention may comprise one or several cells of the type of the first electrochemical cell described above associated with several electrochemical cells of the type of the second electrochemical cell described above, being aware that at least one of the cells of the type of the first electrochemical cell will be bound to at least one of the cells of the type of the second electrochemical cell, as defined above, through an electrically conducting substrate supporting on one of its faces an electrode of the cell of the type of the first electrochemical cell and on another face, an electrode of the cell of the type of the second electrochemical cell.

The generators of the invention, according to the invention are particularly suitable for products requiring compact integration architectures (such as in on-board systems, self-contained systems), where considerable energy is required (this parameter being ensured in our scenario, by the cells of the type of the first electrochemical cells described above) and where considerable power is required (this parameter being ensured in our scenario by cells of the type of the second electrochemical cells described above) while meeting strict safety standards (safety being ensured according to the invention by cells of the type of the second electrochemical cells). This type of requirement may be encountered in the automotive field and more generally in the field of products for the general public. The generators of the invention thus allow integration of both safety and strong storage capacities matching the compactness constraint which on-board use implies.

The invention will now be described with reference to the particular embodiment defined below with reference to the appended FIGURE.

### BRIEF DESCRIPTION OF THE DRAWINGS

The single FIGURE illustrates a generator according to the invention according to a particular embodiment thereof.

### DETAILED DISCUSSION OF PARTICULAR EMBODIMENTS

The appended single FIGURE schematically illustrates a generator for storing electric energy in accordance with a particular embodiment of the invention.

Reference 1 designates an electrochemical cell, a so-called <<high energy cell>> of the type of the first electrochemical cells described above, this cell respectively comprising:
a negative electrode 3, for example in graphite, deposited on an electrically conducting support 5, for example in copper;
a positive electrode 7, for example in LiNi_{0.5}Mn_{1.5}O₄ deposited on an electrically conducting support 9, advantageously in aluminium.

Reference 11 designates the <<safety>> portion of the generator consisting of three identical electrochemical cells respectively numbered as 13, 15 and 17, mounted in series, of the type of the second electrochemical cells described above.

Each of the electrochemical cells 13, 15 and 17 respectively comprises:
a negative electrode (19, 21, 23 respectively), for example in Li₄Ti₅O₁₂;
a positive electrode (25, 27, 29 respectively), for example in LiFePO₄.

The electrochemical cell 13 is in contact with the electrochemical cell 1 via the electrically conducting substrate 9, the negative electrode 19 being deposited on said substrate, on the face opposite to the one where the positive electrode 7 of the electrochemical cell 1 is deposited.

The electrochemical cell 15 is in contact with the electrochemical cell 13 via an electrically conducting substrate 31, one face of this substrate being occupied by the positive electrode 25 of the electrochemical cell 13 and the opposite face being occupied by the negative electrode 21 of the electrochemical cell 15 and is in contact with the electrochemical cell 17 via an electrically conducting substrate 33, one face of this substrate being occupied by the positive electrode 27 of the electrochemical cell 15 and the opposite face being occupied by the negative electrode 23 of the electrochemical cell 17, the positive electrode 29 of the electrochemical cell 17 being deposited on an electrically conducting substrate 35.

The electrically conducting substrates 9, 31, 33 and 35 are advantageously in aluminium.

In each electrochemical cell, an electrolyte as defined above is provided between the negative electrode and the positive electrode (numbered as 37, 39, 41 and 43 in the FIGURE, respectively).

The different constitutive cells of this generator may be electrically connected to each other via electrically conducting substrates 5, 9, 31, 33 and 35 (subsequently called in this discussion, terminals 1, 2, 3, 4 and 5 respectively).

The voltages available on the terminals of each electrochemical cell are included in the appended FIGURE, i.e.:
a voltage of 4.7 V (expressed relatively to the Li⁺/Li pair) between the terminals 1 and 2 of the first electrochemical cell 1, when the negative electrode is in graphite and the positive electrode is in LiNi_{0.5}Mn_{1.5}O₄;
a voltage of 1.9 V (expressed relatively to the Li⁺/Li pair) on the terminals of each of the electrochemical cells 13, 15 and 17 (i.e. between the terminals 2 and 3, between the terminals 3 and 4 and between the terminals 4 and 5, respectively), when the negative electrode is Li₄Ti₅O₁₂ and the positive electrode is LiFePO₄.

Thus, it is possible to adjust the value of the available voltage according to the target application, the available voltage values may be the following:
a voltage of 4.7 V by only electrically connecting the terminals 1 and 2;
a voltage of 1.9 V by electrically connecting one of the electrochemical cells 13, 15 or 17 (via their respective terminals 2 and 3, 3 and 4 or 4 and 5);
a voltage of 5.7 V by electrically connecting the three electrochemical cells 13, 15 or 17 between the terminals 2 and 5;
a voltage of 10.4 V by both electrically connecting the electrochemical cell 1 and the three electrochemical cells 13, 15 and 17 between the terminals 1 and 5.

By connecting the terminals 1 and 2, i.e. by only operating the so-called <<high energy>> cell, the adjacent electrochemical cells 13, 15 and 17 will be capable of absorbing the energy dissipated by the operating cell 1, without this energy degrading the constitutive materials of the electrodes of the cells 13, 15 and 17, because of the inherent cell stability to its materials. The same applies when the so-called <<high energy>> cell operates in parallel with at lest one of the electrochemical cells 13, 15 and 17, these electrochemical cells while delivering voltage may participate without any degradation in the dissipation of heat emitted by the electrochemical cell 1.

1. An electrochemical generator comprising:
at least one first electrochemical cell comprising:
a positive electrode comprising a material selected from the group consisting of lithiated oxides comprising manganese with a spinel structure, lithiated oxides with a lamellar structure and mixtures thereof;
a negative electrode comprising a material selected from the group consisting of carbonaceous materials, mixed oxides of lithium and titanium, titanium dioxide and mixtures thereof;
an electrolyte comprised between said positive electrode and said negative electrode; and
at least one second electrochemical cell comprising:
a positive electrode comprising a material selected from lithiated oxides with polyanionic structures of formula LiMy(XOz)n with M representing an element selected from the group consisting of Mn, Fe, Co, Ni, Cu, Mg, Zn, V, Ca, Sr, Ba, Ti, Al, Si, B and Mo, X representing an element selected from the group consisting of P, Si, Ge, S and As, y, z and n being positive integers;
a negative electrode comprising a material selected from the group consisting of mixed oxides of lithium and titanium, titanium dioxide and mixtures thereof; and
an electrolyte comprised between said positive electrode and said negative electrode;
at least one of said first electrochemical cells and at least one of said second electrochemical cells being bound to each other through an electrically conducting substrate supporting on one of its faces an electrode of said first electrochemical cell and on another face an electrode of said second electrochemical cell.

2. The generator according to claim 1, wherein the lithiated oxides comprising manganese with a spinel structure fits the following formula:
Li₁₋ₐNi_{0.5-b}Mn_{1.5-c}O_{4-d}
with a, b, c and d being comprised between −0.5 and +0.5.

3. The generator according to claim 1, wherein the lithiated oxide comprises comprising manganese with a spinel structure is LiNi_{0.5}Mn_{1.5}O₄.

4. The generator according to claim 1, wherein the lithiated oxide comprising manganese with a spinel structure is LiMn₂O₄ or LiNiMnO₄.

5. The generator according to claim 1, wherein the lithiated oxide with a lamellar structure fits the following formula:
LiMO₂
wherein M is an element selected from the group consisting of Ni, Co, Mn, Al and mixtures thereof.

6. The generator according to claim 1, wherein the lithiated oxide with a lamellar structure fits the following formula:
LiM₂O₃
wherein M is an element selected from the group consisting of Ni, Co, Mn, Al and mixtures thereof.

7. The generator according to claim 1, wherein the positive electrode of the first electrochemical cell is a material consisting of a mixture of:
LiMO₂ wherein M is an element selected from the group consisting of Ni, Co, Mn, Al and mixtures thereof; and
LiM₂O₃ wherein M is an element selected from the group consisting of Ni, Co, Mn, Al and mixtures thereof.

8. The generator according to claim 1, wherein the lithiated oxide with polyanionic structures is LiFePO₄.

9. The generator according to claim 1, wherein the carbonaceous material is carbon or a composite material comprising carbon and a chemical element selected from the group consisting of Sn and Si.

10. The generator according to claim 1, wherein the carbonaceous material is carbon in a form of graphite.

11. The generator according to claim 1, wherein the mixed oxide of lithium and titanium is Li₄Ti₅O₁₂.

12. The generator according to claim 1, comprising at least one first electrochemical cell comprising a positive electrode in LiNi_{0.5}Mn_{1.5}O₄ and a negative electrode in graphite and at least one second electrochemical cell comprising a positive electrode in LiFePO₄ and a negative electrode in Li₄Ti₅O₁₂.

13. The generator according to claim 1, wherein the electrically conducting substrate is aluminium.

14. The generator according to claim 1, wherein the electrolyte is an ionic liquid.

15. The generator according to claim 1, being provided with electrical connections to said first electrochemical cell and with electric connections to said second electrochemical cell.
